(19) United States
(12) Patent Application Publication
(10) Pub. No.: US 2026/0321511 A1
(43) Pub. Date: Oct. 15, 2026

(54) MULTILAYER CERAMIC ELECTRONIC COMPONENT AND MANUFACTURING METHOD OF THE SAME

(71) Applicant: TAIYO YUDEN CO., LTD., Tokyo (JP)

(72) Inventors: Tomoaki NAKAMURA, Tokyo (JP); Kenichi HIRAOKA, Tokyo (JP); Chizuru TOMIKAWA, Tokyo (JP); Junichi SHINOZAKI, Tokyo (JP); Hideya TERAOKA, Tokyo (JP)

(73) Assignee: TAIYO YUDEN CO., LTD., Tokyo (JP)

(21) Appl. No.: 19/693,589

(22) Filed: Jun. 1, 2026

Related U.S. Application Data
(63) Continuation of application No. PCT/JP2024/043213, filed on Dec. 6, 2024.

(30) Foreign Application Priority Data
Dec. 13, 2023 (JP) 2023-210194

(51) Int. Cl. H01G 4/30; H01G 4/232

(52) U.S. Cl. CPC H01G 4/30; H01G 4/2325

(57) ABSTRACT

A multilayer ceramic electronic component includes an element body, in which internal electrodes and dielectric layers mainly composed of ceramic are alternately laminated in a first direction, having end surfaces facing each other and a neighboring surface connected to the end surfaces, an external electrode that includes a base metal layer and a plating layer and is provided on the element body, and a glass layer provided on an end portion of the neighboring surface at a side of one of the end surfaces, wherein the base metal layer is provided at the end portion, the glass layer is provided from under a tip portion of the base metal layer to an opposite side of the end surfaces on the end portion, and the plating layer is provided so as to sandwich the base metal layer and the glass layer with the element body at the end portion.

### CROSS-REFERENCE TO RELATED APPLICATIONS

This application is a continuation application of PCT/JP2024/043213 filed on Dec. 6, 2024, which claims priorities of Japanese Patent Applications No. 2023-210194 filed on Dec. 13, 2023, the entire contents of each are incorporated herein by reference.

### FIELD

A certain aspect of the present disclosure relates to a multilayer ceramic electronic component and a manufacturing method of the same.

### BACKGROUND

In external electrodes of the multilayer ceramic electronic component such as a multilayer ceramic capacitor, it is known that an organic layer is formed on a tip of a base metal layer and a tip of a plating layer covering the base metal layer is provided on the organic layer (Refer to, for example, Japanese Unexamined Patent Publication No. 2018-49881.).

### SUMMARY OF THE INVENTION

According to a first aspect of the present disclosure, there is provided a multilayer ceramic electronic component including: an element body, in which internal electrodes and dielectric layers mainly composed of ceramic are alternately laminated in a first direction, having end surfaces facing each other in a second direction and a neighboring surface connected to the end surfaces, the internal electrodes being alternately drawn to the end surfaces; an external electrode that includes a base metal layer and a plating layer and is provided on the element body; and a glass layer provided on an end portion of the neighboring surface at a side of one of the end surfaces, wherein the base metal layer contacts a part of the internal electrodes drawn to the one of the end surfaces and is provided at the end portion, the glass layer is provided from under a tip portion of the base metal layer to an opposite side of the end surfaces on the end portion, and the plating layer is provided so as to sandwich the base metal layer and the glass layer with the element body at the end portion.

According to a second aspect of the present disclosure, there is provided a manufacturing method of a multilayer ceramic electronic component, including: preparing an element body, in which internal electrodes and dielectric layers mainly composed of ceramic are alternately laminated in a first direction, having end surfaces facing each other in a second direction and a neighboring surface connected to the end surfaces, the internal electrodes being alternately drawn to the end surfaces; applying first conductive paste containing glass powder including silicon oxide so as to contact an end portion of the neighboring surface at a side of one of the end surfaces; applying second conductive paste having a lower concentration of Si oxide than the first conductive paste so as to contact the one of the end surfaces; baking the first conductive paste and the second conductive paste to form a base metal layer and a glass layer, the base metal layer being provided at the end portion and contacting a part of the internal electrodes drawn to the one of the end surfaces, the glass layer containing silicon oxide and being provided from under a tip portion of the base metal layer to an opposite side of the end surfaces on the end portion; and forming a plating layer at the end portion so as to sandwich the base metal layer and the glass layer with the element body, the plating layer and the base metal layer forming an external electrode of the multilayer ceramic electronic component.

According to a third aspect of the present disclosure, there is provided a manufacturing method of a multilayer ceramic electronic component, including: preparing an element body, in which internal electrodes and dielectric layers mainly composed of ceramic are alternately laminated in a first direction, having end surfaces facing each other in a second direction and a neighboring surface connected to the end surfaces, the internal electrodes being alternately drawn to the end surfaces; applying paste containing silicon oxide on an end portion of the neighboring surface at a side of one of the end surfaces without applying the paste on the one of the end surfaces; applying conductive paste on the one of the end surfaces of the element body and the paste; baking the paste and the conductive paste to form a base metal layer and a glass layer, the base metal layer being provided at the end portion and contacting a part of the internal electrodes drawn to the one of the end surfaces, the glass layer containing silicon oxide and being provided from under a tip portion of the base metal layer to an opposite side of the end surfaces on the end portion; and forming a plating layer at the end portion so as to sandwich the base metal layer and the glass layer with the element body, the plating layer and the base metal layer forming an external electrode of the multilayer ceramic electronic component.

### BRIEF DESCRIPTION OF THE DRAWINGS

FIG. 1 is a partial cross-sectional perspective view of a multilayer ceramic capacitor 100 according to a first embodiment.

FIG. 2 is a cross-sectional view taken along a line A-A of FIG. 1.

FIG. 3 is a cross-sectional view taken along a line B-B of FIG. 1.

FIG. 4 is a flowchart illustrating a manufacturing method of a multilayer ceramic capacitor in the first embodiment.

FIG. 5A is a cross-sectional view illustrating a manufacturing method of a multilayer ceramic capacitor according to the first embodiment.

FIG. 5B is a cross-sectional view illustrating a manufacturing method of a multilayer ceramic capacitor according to the first embodiment.

FIG. 6A is a cross-sectional view illustrating a manufacturing method of a multilayer ceramic capacitor according to the first embodiment.

FIG. 6B is a cross-sectional view illustrating a manufacturing method of a multilayer ceramic capacitor according to the first embodiment.

FIG. 7 is a cross-sectional view illustrating a manufacturing method of a multilayer ceramic capacitor according to the first embodiment.

FIG. 8 is a cross-sectional view of a comparative multilayer ceramic capacitor.

FIG. 9 is a cross-sectional view illustrating a manufacturing method of a multilayer ceramic capacitor according to the first embodiment.

FIG. 10 is a cross-sectional view of a multilayer ceramic capacitor according to a modification of the first embodiment.

FIG. 11 is a cross-sectional view of a multilayer ceramic capacitor according to a second embodiment.

FIG. 12A is a cross-sectional view illustrating a manufacturing method of a multilayer ceramic capacitor according to the second embodiment.

FIG. 12B is a cross-sectional view illustrating a manufacturing method of a multilayer ceramic capacitor according to the second embodiment.

FIG. 13A is a cross-sectional view illustrating a manufacturing method of a multilayer ceramic capacitor according to the second embodiment.

FIG. 13B is a cross-sectional view illustrating a manufacturing method of a multilayer ceramic capacitor according to the second embodiment.

FIG. 14 is a cross-sectional view of a multilayer ceramic capacitor according to a modification of the second embodiment.

FIG. 15 is a cross-sectional view of a multilayer ceramic capacitor according to a third embodiment.

FIG. 16A is a cross-sectional view illustrating a manufacturing method of a multilayer ceramic capacitor according to the third embodiment.

FIG. 16B is a cross-sectional view illustrating a manufacturing method of a multilayer ceramic capacitor according to the third embodiment.

FIG. 17 is a cross-sectional view illustrating a manufacturing method of a multilayer ceramic capacitor according to the third embodiment.

### DETAILED DESCRIPTION

In a process of forming the plating layer, components of a plating solution and the like may pervade through an interface between the base metal layer and an element body. This may cause corrosion of internal electrodes and the like.

Referring to the drawings, embodiments will be described below by taking a multilayer ceramic capacitor as an example of a multilayer ceramic electronic component.

### First Embodiment

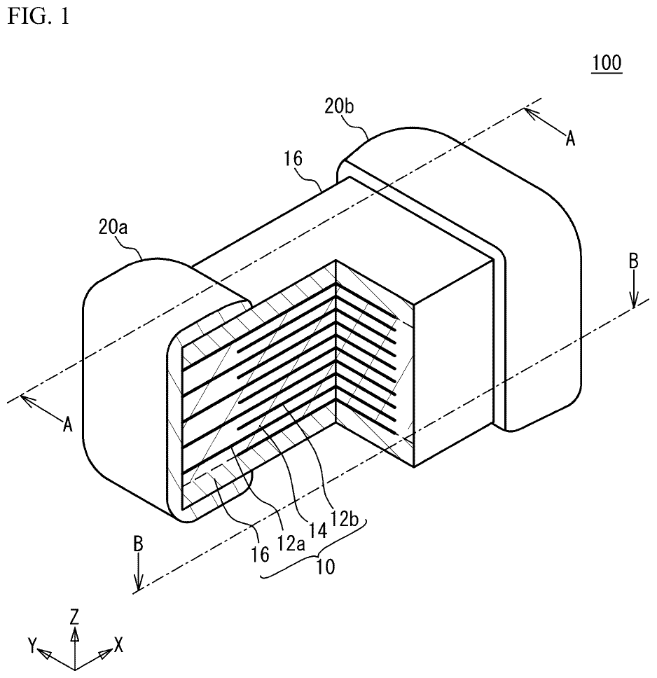

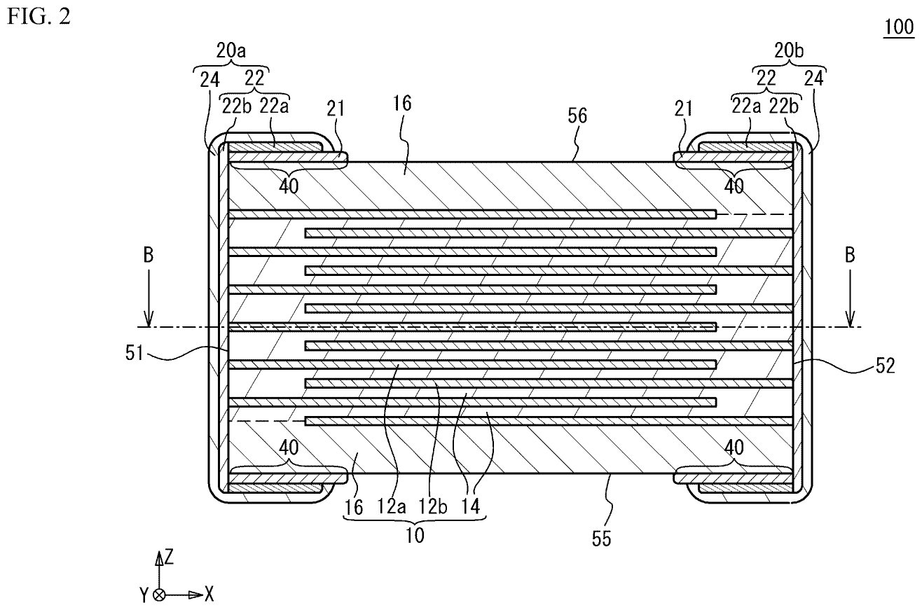

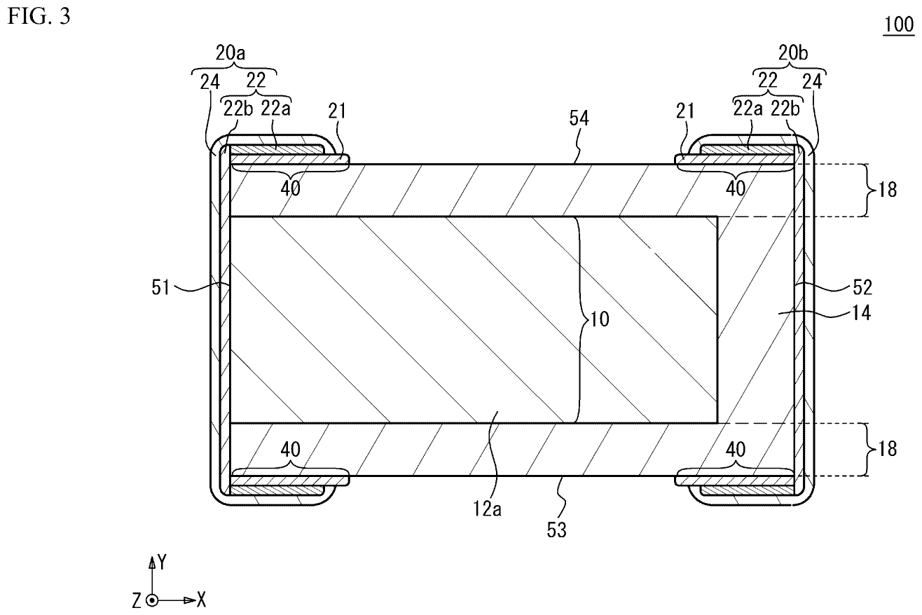

FIG. 1 is a partial cross-sectional perspective view of a multilayer ceramic capacitor 100 according to the first embodiment. FIG. 2 is a cross-sectional view taken along the line A-A of FIG. 1. FIG. 3 is a cross-sectional view taken along the line B-B of FIG. 1.

In FIGS. 1 to 3, a Z direction (a first direction) is a laminating direction in which dielectric layers 14 and internal electrodes 12a and 12b are laminated, and is a direction in which a lower surface 55 and an upper surface 56 of an element body 10 face each other. An X direction (a second direction) is a length direction of the element body 10, and is a direction in which a pair of end surfaces 51 and 52 of the element body 10 face each other. A Y direction (a third direction) is a width direction of the internal electrodes 12a and 12b, and is a direction in which side surfaces 53 and 54 of the element body 10 face each other. The X direction, the Y direction, and the Z direction intersect or are orthogonal to each other.

The multilayer ceramic capacitor 100 is provided with the element body 10 having a substantially rectangular parallelepiped shape and external electrodes 20a and 20b. The element body 10 has the dielectric layers 14, the internal electrodes 12a and 12b, and cover dielectric layers 16. The internal electrodes 12a and 12b are alternately laminated. Each of the dielectric layers 14 is provided between a pair of the internal electrodes 12a and 12b. The outermost layers in the laminating direction (the Z direction) of a laminate, in which the dielectric layers 14 and the internal electrodes 12a and 12b are laminated, are the internal electrodes 12a and 12b, and a lower surface and an upper surface of the laminate are respectively covered with the cover dielectric layers 16. Regions beside each of the internal electrodes 12a and 12b in the Y direction is side margin regions 18.

The internal electrodes 12a and 12b are alternately drawn to the end surfaces 51 and 52. The internal electrode 12a is drawn to the end surface 51, and the internal electrode 12b is not drawn to the end surface 51. The internal electrode 12b is drawn to the end surface 52, and the internal electrode 12a is not drawn to the end surface 52. That is, the internal electrodes 12a and 12b are connected to the different end surfaces 51 and 52.

The external electrode 20a is in contact with the internal electrode 12a on the end surface 51. The external electrode 20a covers the end surface 51, and also covers one end portion 40 of each of the side surfaces 53 and 54, the lower surface 55, and the upper surface 56 at a side of the end surface 51 in the X direction. The external electrode 20b is in contact with the internal electrode 12b on the end surface 52. The external electrode 20b covers the end surface 52, and also covers another end portion 40 of each of the side surfaces 53 and 54, the lower surface 55, and the upper surface 56 at a side of the end surface 52 in the X direction. The end portions 40 are located at both sides of each of the surfaces 53, 54, 55 and 56 in the X direction, and are respectively connected to the end surfaces 51 and 52 of the element body 10. The side surfaces 53 and 54, the lower surface 55, and the upper surface 56 are examples of a neighboring surface connected to the end surfaces 51 and 52.

Each of the external electrodes 20a and 20b includes a base metal layer 22 and a plating layer 24 provided to cover the base metal layer 22. The base metal layer 22 includes metal layers 22a and 22b. The metal layer 22a is provided at the end portion 40. A glass layer 21 is provided on the end portion 40 and is partially sandwiched between the metal layer 22a and the element body 10. The glass layer 21 is exposed from under the tip portion of the metal layer 22a. The metal layer 22b is provided on each of the end surfaces 51 and 52. The glass layer 21 is not provided on the end surfaces 51 and 52, and the metal layers 22b on the end surfaces 51 and 52 are respectively in contact with the internal electrodes 12a and 12b. The plating layer 24 is provided so as to cover the base metal layer 22. The tip portion of the plating layer 24 is in contact with the glass layer 21 and is not in contact with the element body 10.

The size of the multilayer ceramic capacitor 100 is, for example, a length of 0.25 mm (length in the X direction), a width of 0.125 mm (width in the Y direction), and a height of 0.125 mm (height in the Z direction), or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm, but is not limited to these sizes.

The internal electrodes 12a and 12b are mainly composed of a base metal such as nickel (Ni), copper (Cu), tin (Sn), or the like. As the internal electrodes 12a and 12b, a noble metal such as platinum (Pt), palladium (Pd), silver (Ag), or gold (Au), or an alloy containing these metals may be used. The thickness of the internal electrodes 12a and 12b is, for example, 0.1 μm or more and 1 μm or less.

The dielectric layer 14 has, for example, a ceramic material having a perovskite structure represented by a general formula ABO₃ as a main phase. The perovskite structure contains ABO_{3-α} that is not in the stoichiometric composition. For example, the ceramic material can be selected from at least one of BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) forming a perovskite structure, and the like. Ba_{1-x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, or the like. For example, the dielectric layers 14 contain 90 at % or more of the main component ceramic. The thickness of the dielectric layers 14 is, for example, 0.3 μm or more and 2 μm or less.

Additives may be added to the dielectric layers 14. Examples of additives to the dielectric layers 14 include oxides of zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm) and ytterbium (Yb)), oxides containing cobalt (Co), nickel (Ni), lithium (Li), boron (B), sodium (Na), potassium (K) or silicon (Si), or glasses containing cobalt, nickel, lithium, boron, sodium, potassium or silicon.

The composition of the main ceramic component of the cover dielectric layers 16 may be the same as or different from that of the main ceramic of the dielectric layers 14.

The base metal layer 22 is mainly composed of a metal such as copper, nickel, aluminum (Al), or zinc (Zn), or an alloy of two or more of these metals (for example, an alloy of copper and nickel), and includes a ceramic such as a glass component for densification of the base metal layer 22, a common material for controlling the sinterability of the external electrodes 20a and 20b, and the like. The glass component is an oxide such as barium (Ba), strontium (Sr), calcium (Ca), zinc (Zn), aluminum (Al), silicon (Si) or boron (B), or the like. The common material is, for example, a ceramic component having a main component which is the same material as the main component of the dielectric layers 14. A concentration of silicon oxide of the metal layer 22a is greater than that of the metal layer 22b. In the following example, the concentration of silicon oxide is a concentration of SiO₂. The base metal layer 22 has a thickness of, for example, 3 μm or more and 50 μm or less. The concentration of silicon oxide of the metal layers 22a and 22b is, for example, 5 mol % or more.

It can be demonstrated that the concentration of silicon oxide of the metal layer 22a is greater than that of the metal layer 22b by measuring the concentration (at %) of Si element (Si concentration) in the metal layers 22a and 22b, as described below, using, for example, a scanning transmission electron microscope (STEM)—energy dispersive X-ray spectroscopy (EDS) method. The Si concentration of the metal layer 22a is greater than that of the metal layer 22b.

The plating layer 24 is mainly composed of a metal such as copper, nickel, aluminum, zinc or tin, or an alloy of two or more of these metals. The plating layer 24 may be a plating layer of a single metal component or a plurality of plating layers of different metal components. Further, a film of a conductive resin such as an epoxy resin or a urethane resin may be formed on the surface of the plating layer 24. The thickness of the plating layer 24 is, for example, 5 μm or more and 15 μm or less.

The glass layer 21 is mainly composed of silicon oxide (for example, silicon dioxide), and may contain other metal oxides. The thickness of the glass layer 21 is, for example, 0.1 μm or more and 5 μm or less.

### First Embodiment of Manufacturing Method

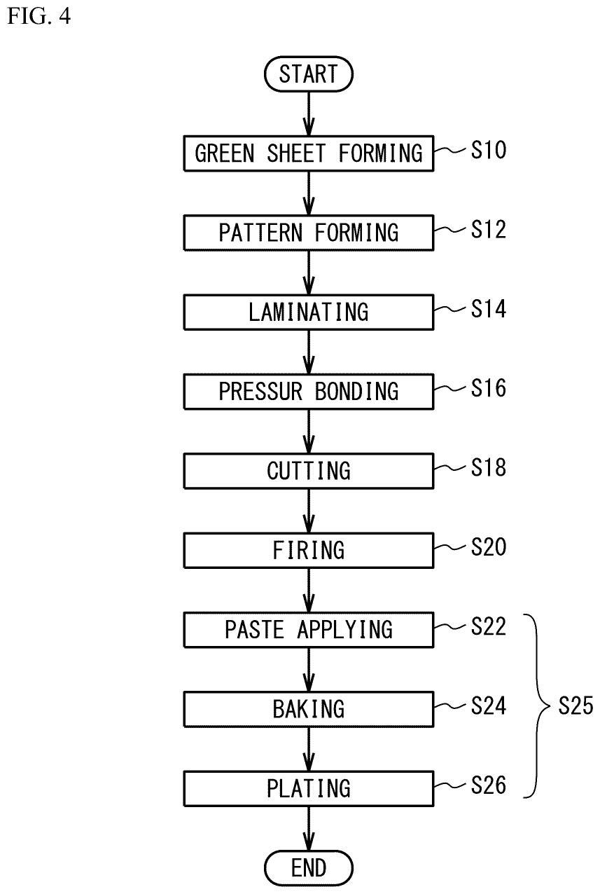

A manufacturing method of the multilayer ceramic capacitor 100 is described below. FIG. 4 is a flowchart illustrating the manufacturing method of the multilayer ceramic capacitor 100 in the first embodiment.

### Green Sheet Forming Process

First, a green sheet is formed (green sheet forming process S10). In the green sheet forming process S10, for example, dielectric materials are prepared by adding various additive compounds (sintering aids and the like) to ceramic powder. A binder such as polyvinyl butyral (PVB) resin, an organic solvent such as ethanol or toluene, and a plasticizer are added to the prepared dielectric material to form a slurry by wet mixing. The slurry is used to coat a green sheet on a substrate, for example, by a die coater method or a doctor blade method. The substrate is, for example, a PET (polyethylene terephthalate) film. Thereafter, the green sheet is dried.

### Pattern Forming Process

Subsequently, metal patterns, which form the internal electrodes 12a and 12b afterwards, are formed on the green sheet (pattern forming process S12). In the pattern forming process S12, a conductive paste containing an organic binder is used to print the metal patterns on the green sheet on the substrate by, for example, a gravure printing method to form the internal electrodes 12a and 12b. Thus, the metal patterns corresponding to the internal electrodes 12a and 12b are formed on the green sheet with a space therebetween. The conductive paste contains metal powder such as nickel powder or the like as a main component, a binder, and an organic solvent. Ceramic particles may be added to the conductive paste as a common material.

### Laminating Process

Subsequently, a plurality of the green sheets is laminated (laminating process S14). In the laminating process S14, the laminated sheets are formed by laminating the green sheets on which the metal patterns are printed to form the internal electrodes 12a and 12b. Additional green sheets corresponding to the cover dielectric layer 16 are respectively laminated on both end surfaces of the laminated sheets in the laminating direction.

### Pressure Bonding Step

Subsequently, the laminated sheets are pressure-bonded (pressure bonding process S16). In the pressure bonding process S16, the laminated sheets formed in the process S14 is pressed to bond the green sheets. For example, a hydrostatic press is used as the pressure bonding means.

### Cutting Process

Subsequently, the laminated sheets are cut (cutting process S18). In the cutting process S18, the laminated sheets are cut along a predetermined cut line in the laminating direction by a cutting blade to prepare the multiple element bodies 10. In each of the element bodies 10, the internal electrode 12a is exposed from the end surface 51, and the internal electrode 12b is exposed from the end surface 52. After the process S18, the element bodies 10 may be polished by a technique such as barrel polishing or the like. Thus, corner portions of each of the element bodies 10 is rounded.

### Firing Process

Subsequently, the element body 10 is fired (firing process S20). In the firing process S20, the element body 10 is debinded in a nitrogen gas atmosphere at 250° C. to 500° C., and then fired at 1300° C. to 1400° C. for about one hour in a reducing atmosphere. Thus, particles in the element body 10 and particles in the internal electrodes 12a and 12b are sintered.

### External Electrodes Forming Process

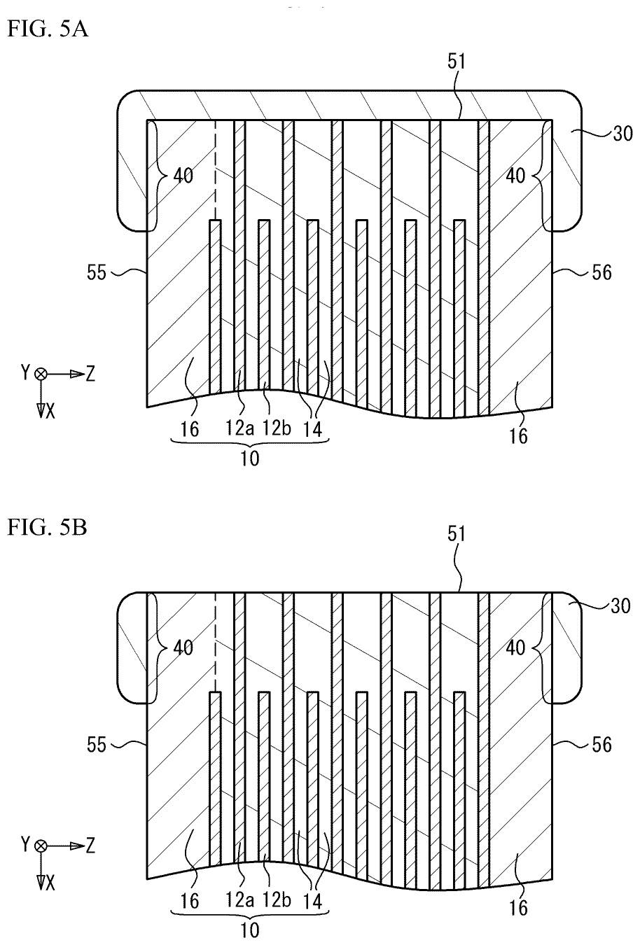

Subsequently, the external electrodes 20a and 20b are formed (external electrodes forming process S25). The external electrodes forming process S25 includes process S22, S24 and S26. FIGS. 5A to 7 are cross-sectional views illustrating the manufacturing method of the multilayer ceramic capacitor 100 according to the first embodiment. In FIGS. 5A to 7, configuration at a side of the end surface 52 is not illustrated, but is the same as that at side of the end surface 51. This manner is applied to other figures.

First, paste 30 is applied to the element body 10 (paste applying process S22). As illustrated in FIG. 5A, the paste 30 is applied to the end portions 40 and the end surface 51 of the element body 10 by, for example, a dip method. The paste 30 contains metal powder such as copper powder as a main component, a glass powder (glass frit) containing silicon oxide, a binder, and an organic solvent. The glass powder may contain at least one metal oxide selected from barium oxide, zinc oxide, calcium oxide, aluminum oxide, magnesium oxide, boron oxide and the like. The concentration of SiO₂ in the glass powder in the paste 30 is, for example, 30 mol % or more and 98 mol % or less.

As illustrated in FIG. 5B, the paste 30 applied to the end surface 51 is removed using a blotting paper or the like. The paste 30 provided on each of the end portions 40 remains.

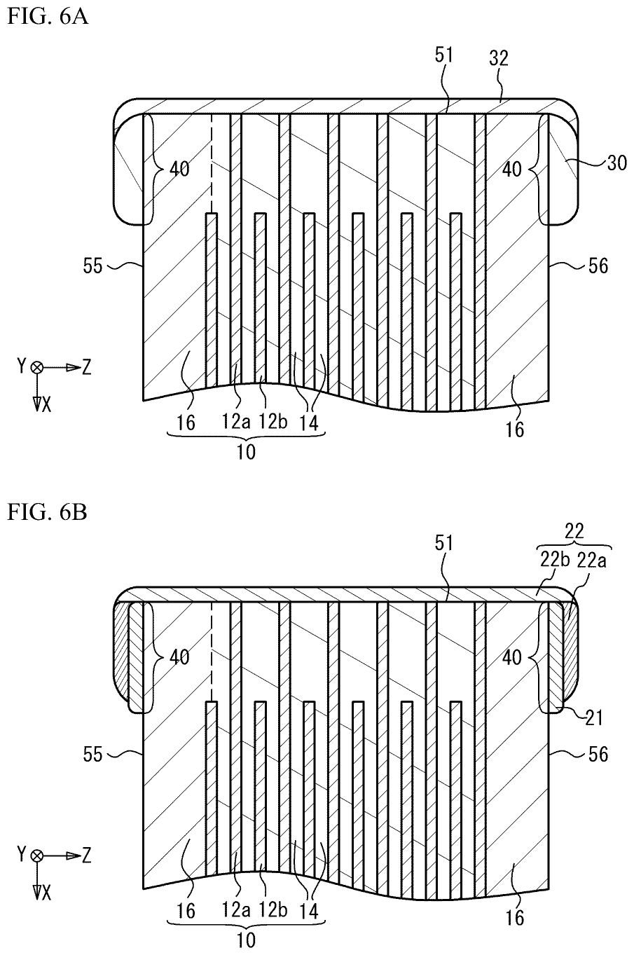

As illustrated in FIG. 6A, paste 32 is applied to the end surface 51 of the element body 10 by, for example, a dip method. The paste 32 contains a metal powder such as copper powder as a main component, glass powder, a binder, and an organic solvent. The glass powder contains little silicon oxide, and contains at least one metal oxide selected from barium oxide, zinc oxide, calcium oxide, aluminum oxide, magnesium oxide, boron oxide and the like. The concentration of SiO₂ in the glass powder in the paste 32 is lower than the concentration of SiO₂ in the glass powder in the paste 30, for example, 5 mol % or more and 30 mol % or less.

Next, the pastes 30 and 32 are baked (baking process S24). In the baking process S24, the pastes 30 and 32 are baked in a nitrogen atmosphere at a temperature of 750° C. to 850° C., which is lower than the baking temperature in the process S22. Thus, the pastes 30 and 32 are baked on the element body 10.

As illustrated in FIG. 6B, the paste 30 is baked so that the glass layer 21 and the metal layer 22a are formed from the paste 30. The glass layer 21 is in contact with the element body 10 and contains silicon oxide as a main component. The glass layer 21 may contain, in addition to silicon oxide, a component of the glass powder in the paste 30 and an oxide of an element in the element body 10. The glass layer 21 may include a metal such as copper in the paste 30, but has a higher resistivity than the metal layer 22a and is an insulator. The glass layer 21 is an inorganic insulator containing silicon oxide and metal oxide, and is amorphous. The metal layer 22a sandwiches the glass layer 21 with the element body 10. The tip portion of the glass layer 21 protrudes from under the tip portion of the metal layer 22a. That is, the tip portion of the glass layer 21 is exposed from the metal layer 22a. The metal layer 22a is mainly composed of a metal such as copper and includes a component of the glass powder in the paste 30.

The metal layer 22b is formed on the end surface 51 of the element body 10 from the paste 32. The metal layer 22b is mainly composed of a metal such as copper and is in contact with the internal electrode 12a exposed from the end surface 51 of the element body 10. The metal layer 22b is mainly composed of a metal such as copper and includes a component of the glass powder in the paste 32. The silicon oxide concentration in the metal layer 22b is lower than that in the metal layer 22a. The metal layers 22a and 22b form the base metal layer 22.

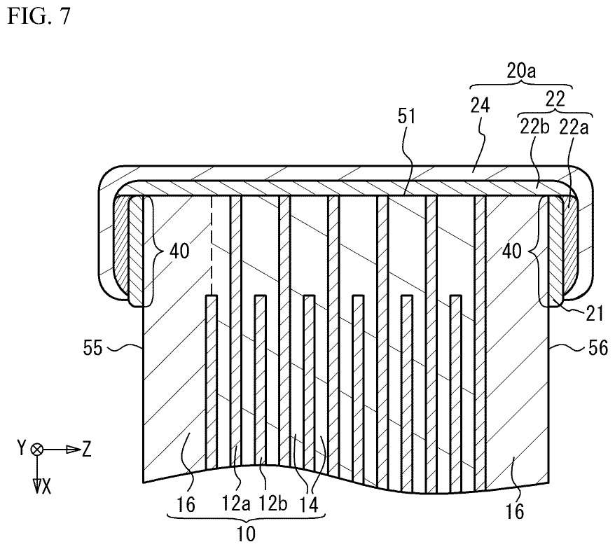

Next, the plating layer 24 is formed (plating process S26). As illustrating in FIG. 7, in the process S26, the plating layer 24 is formed so as to cover the base metal layer 22. The base metal layer 22 and the plating layer 24 form the external electrodes 20a and 20b. The plating layer 24 includes, for example, a layer containing copper as a main component, a layer containing nickel as a main component, and a layer containing tin as a main component in an order from the base metal layer 22 side. The base metal layer 22 and the plating layer 24 form the external electrodes 20a and 20b.

### Comparative Multilayer Ceramic Capacitor

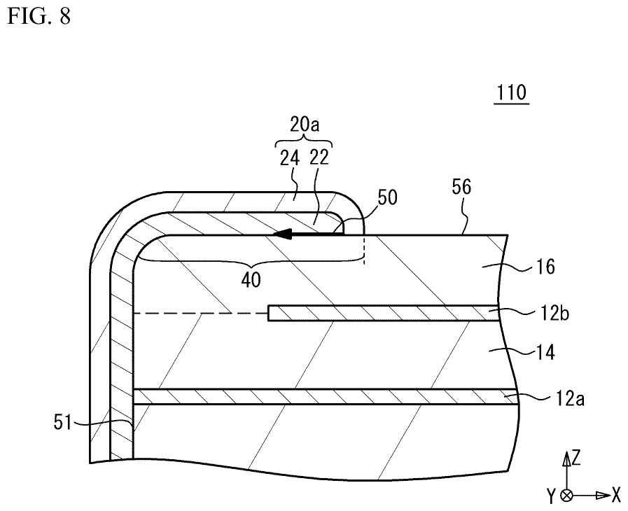

FIG. 8 is a cross-sectional view of a comparative multilayer ceramic capacitor, and is an enlarged cross-sectional view of a vicinity of a corner portion of the end surface 51 and the upper surface 56. As illustrated in FIG. 8, in the comparative multilayer ceramic capacitor, the glass layer 21 is not provided, and the base metal layer 22 is in contact with the end portion 40 of the element body 10. The plating layer 24 is provided so as to cover the base metal layer 22. When the plating layer 24 is formed, moisture or a corrosive compound in a plating solution may pervade an interface between the element body 10 and the base metal layer 22 as indicated by an arrow 50, and may reach the end surface 51. This may cause a corrosion of the internal electrode 12a and the like. Additionally, when the comparative multilayer ceramic capacitor is mounted on a circuit board, it is also concerned that flux for soldering pervades the interface between the element body 10 and the base metal layer 22. Thus, a resistance to the plating solution and the moisture are weakened.

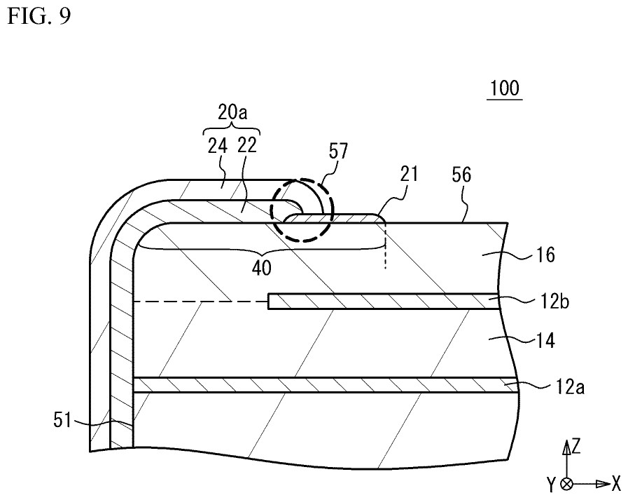

FIG. 9 is a cross-sectional view of the multilayer ceramic capacitor 100 of the first embodiment, and is an enlarged cross-sectional view of the vicinity of a corner portion of the end surface 51 and the upper surface 56. As illustrated in FIG. 9, in the multilayer ceramic capacitor 100 of the first embodiment, the base metal layer 22 contacts the internal electrodes 12a drawn to the end surface 51, and is provided on the end surface 51 and the end portions 40 of the element body 10. As indicated by a range 57 of a broken line, the glass layer 21 is provided from under a tip portion of the base metal layer 22 to an opposite side of the end surface 51 on the end portion 40. The plating layer 24 is provided so as to sandwich the base metal layer 22 and the glass layer 21 with the element body 10 at the end portion 40. Thus, when the plating layer 24 is formed, the glass layer 21 works as a barrier for the moisture or the corrosive compound in the plating solution, and the moisture or the corrosive compound can be prevented from pervading the interface between the element body 10 and the base metal layer 22. Therefore, the corrosion of the internal electrodes 12a and the like can be suppressed. Additionally, when the multilayer ceramic capacitor 100 is mounted on the circuit board, the flux for soldering can be suppressed from pervading the interface between the element body 10 and the base metal layer 22. In this way, the resistance to the plating solution and the moisture can be strengthened.

The glass layer 21 includes silicon oxide. The glass layer 21 containing silicon oxide has good adhesion to the base metal layer 22 and the element body 10. Therefore, the pervasion of the moisture and the corrosive compound in the interface between the glass layer 21 and the element body 10 and the interface between the glass layer 21 and the base metal layer 22 can be suppressed. In order to improve adhesion, a concentration of SiO₂ in the glass layer 21 is preferably 50 mol % or more, more preferably 75 mol % or more, or still more preferably 90 mol % or more.

As illustrated in FIGS. 5A and 5B, the paste 30 (first conductive paste) containing glass powder including silicon oxide is applied so as to contact the end portion 40 of the element body 10. As illustrated in FIG. 6A, the paste 32 (second conductive paste) having a lower concentration of silicon oxide than the paste 30 is applied so as to contact the end surface 51. As illustrated in FIG. 6B, the pastes 30 and 32 are baked to form the base metal layer 22 and the glass layer 21. Thus, the paste 30 applied to the end portion 40 contains the glass powder including silicon oxide. Thus, the glass layer 21 containing silicon oxide can be formed between the element body 10 and the metal layer 22a by the baking process.

When the paste 30 containing the glass powder including a large amount of silicon oxide is provided on the end surface 51, a contact resistance between the internal electrodes 12a and the base metal layer 22 increases. Therefore, as illustrated in FIG. 5B, the paste 30 is formed on the end portions 40 so that the paste 30 is not provided on the end surface 51. Thereafter, as illustrated in FIG. 6A, the paste 32 is applied so as to contact the end surface 51. Thereafter, the baking process is performed as illustrated in FIG. 6B. Thus, the glass layer 21 provided on the end portion 40 and the metal layer 22a (first layer) sandwiching the glass layer 21 with the end portion 40 of the element body 10 are formed by baking the paste 30. The metal layer 22b (second layer) having a lower silicon oxide concentration than the metal layer 22a is formed by baking the paste 32, so as to contact the end surface 51. The metal layer 22a is not provided on the end surface 51. Since the metal layer 22b with a lower concentration of silicon oxide is in contact with the internal electrodes 12a, a contact resistance between the internal electrodes 12a and the base metal layer 22 can be lowered.

The baking temperature of the paste 30 containing the glass powder with a large amount of silicon oxide is higher than the baking temperature of the paste 32 containing the glass powder with a small amount of silicon oxide. Therefore, the baking process of the paste 30 and the baking process of the paste 32 may be performed separately, and the baking temperature of the paste 30 with silicon oxide may be set higher than the baking temperature of the paste 32.

It can be demonstrated that the concentration of silicon oxide of the paste 30 is higher than that of the paste 32 by measuring the Si concentrations of the pastes 30 and 32, using, for example, the STEM-EDS method, as described below. The Si concentration of the paste 30 is higher than that of the paste 32.

The concentration of silicon oxide of the metal layer 22a is preferably twice or more, more preferably three times or more, and still more preferably ten times or more that of the metal layer 22b. The concentration of silicon oxide of the metal layer 22b is, for example, 5 mol % or more and 30 mol % or less. The concentration of silicon oxide of the metal layer 22a is, for example, 50 mol % or more and 99 mol % or less. The concentration of silicon oxide of the metal layers 22a and 22b is the molar ratio of SiO₂ in the glass (i.e., an inorganic insulator containing silicon oxide and metal oxide) contained in the metal layers 22a and 22b.

### Modification of First Embodiment

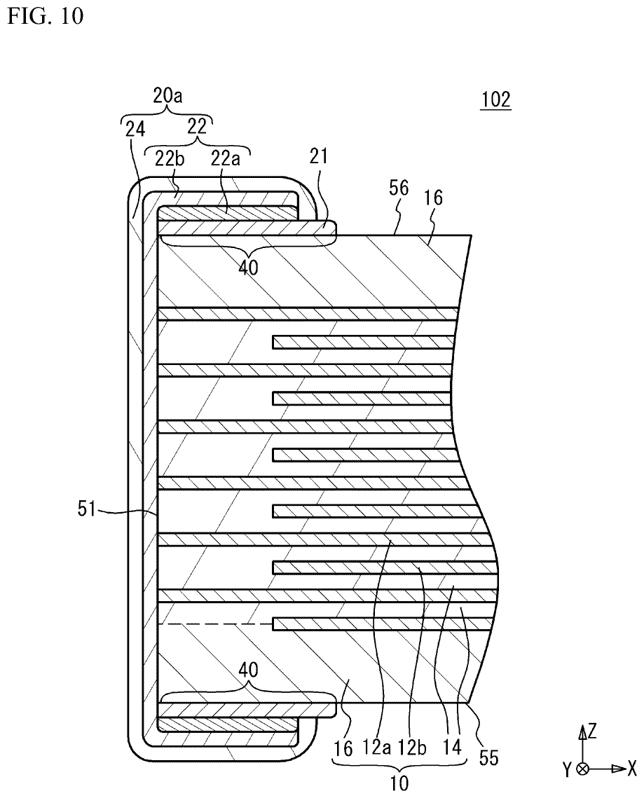

FIG. 10 is a cross-sectional view of a multilayer ceramic capacitor 102 according to a modification of the first embodiment. As illustrated in FIG. 10, in the multilayer ceramic capacitor 102 of the modification of the first embodiment, the metal layer 22b is provided so as to cover the metal layer 22a at the end portions 40. The other configuration is the same as that of the first embodiment, and the descriptions thereof are omitted. As in the modification of the first embodiment, the metal layer 22b may cover at least a part of the metal layer 22a on the end portion 40.

### Second Embodiment

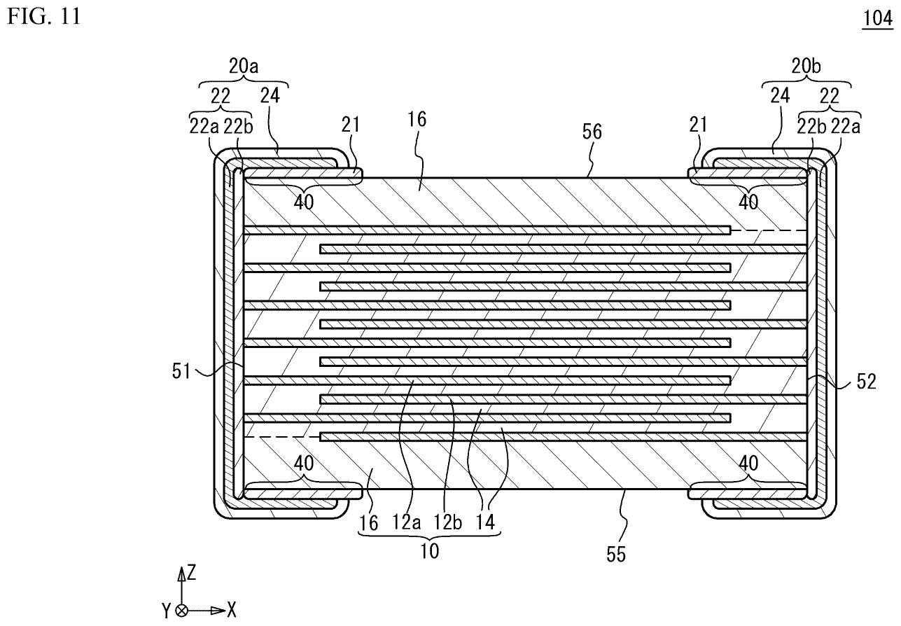

FIG. 11 is a cross-sectional view of a multilayer ceramic capacitor 104 according to the second embodiment. As illustrated in FIG. 11, in the multilayer ceramic capacitor 104 of the second embodiment, the metal layer 22b is provided so as to be in contact with the end surface 51, and is almost unprovided on the end portions 40. The glass layers 21 are provided on the end portions 40 of the element body 10. The metal layers 22a are provided so as to be in contact with the metal layers 22b on the end surfaces 51 and 52 and the glass layers 21 on the end portions 40. The plating layers 24 are provided so as to cover the base metal layers 22, and the tip of the plating layer 24 is in contact with the glass layer 21 and not in direct contact with the element body 10. The other configuration is the same as that of the first embodiment, and the descriptions thereof are omitted.

### Manufacturing Method of Second Embodiment

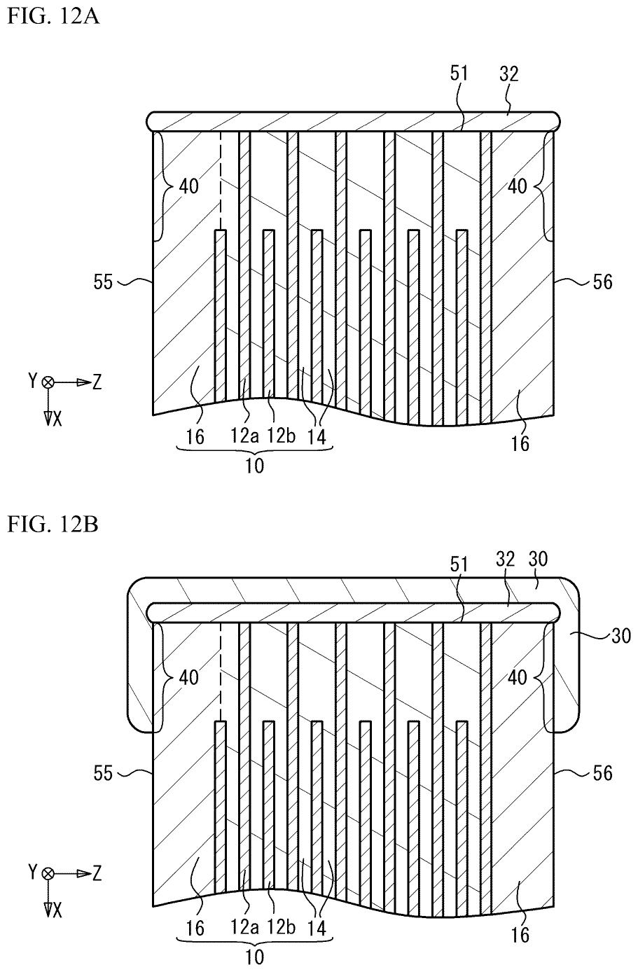

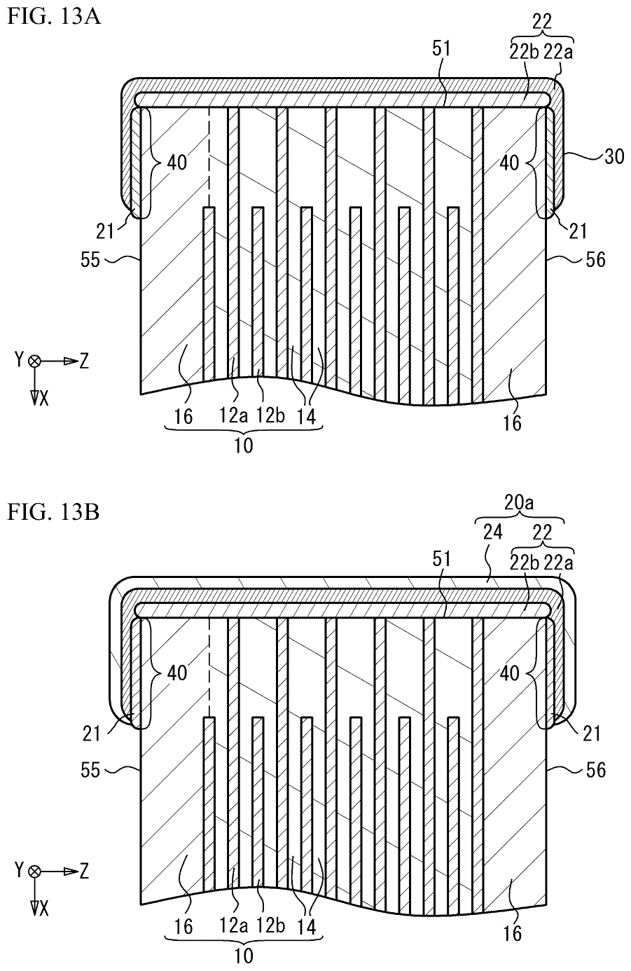

First, the processes up to the firing process S20 in FIG. 4 are performed. FIGS. 12A to 13B are cross-sectional views illustrating the manufacturing method of the multilayer ceramic capacitor 104 according to the second embodiment. In a paste applying process S22 after the firing process S20, as illustrated in FIG. 12A, the paste 32 is applied to the end surface 51 of the element body 10. At this time, almost none of the paste 32 is applied to the end portion 40. As illustrated in FIG. 12B, the paste 30 is applied so as to cover the paste 32 on the end surface 51 and the end portions 40. The pastes 30 and 32 are applied by, for example, a dip method.

As illustrated in FIG. 13A, the glass layers 21 and the metal layer 22a are formed from the paste 30 by baking the pastes 30 and 32. The glass layer 21 covers the end portions 40, and the metal layer 22a covers the glass layers 21 and the metal layer 22b. As illustrated in FIG. 13B, the plating layer 24 is formed so as to cover the metal layer 22a. The base metal layer 22 and the plating layer 24 form the external electrode 20a.

In the second embodiment, after the paste 32 in contact with the end surface 51 is applied as illustrated in FIG. 12A, the paste 30 is applied so as to cover the paste 32 as illustrated in FIG. 12B. Thereafter, the baking process is performed as illustrated in FIG. 13A. Thus, the metal layer 22a (first layer) is formed so as to sandwich the glass layers 21 with the element body 10 at the end portion 40. The metal layer 22b (second layer) having a lower concentration of silicon oxide than the metal layer 22a is also formed so as to contact the end surface 51. Additionally, the metal layer 22a is provided so that the metal layer 22b is sandwiched between the end surface 51 and the metal layer 22a. Since the metal layer 22b having the lower concentration of silicon oxide is in contact with the internal electrodes 12a, a connectivity between the internal electrodes 12a and the base metal layer 22 is improved.

### Modification of Second Embodiment

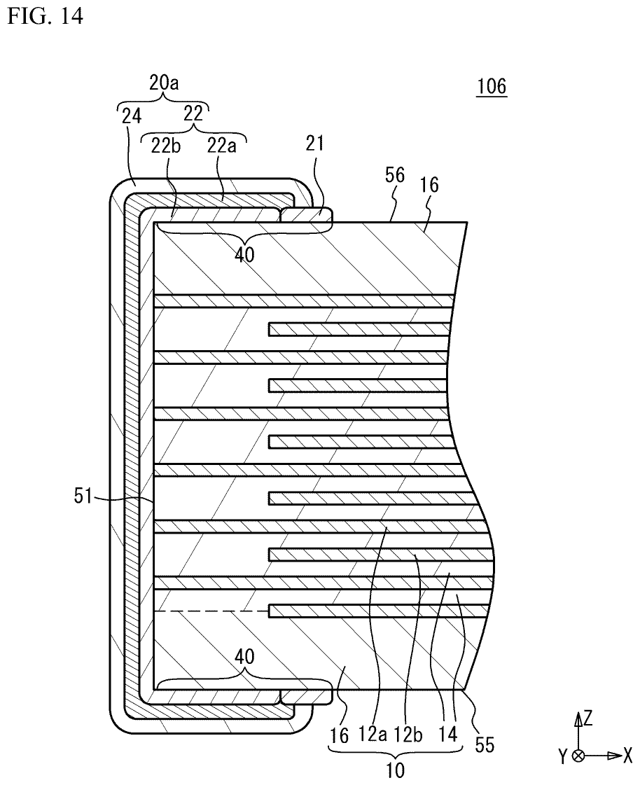

FIG. 14 is a cross-sectional view of a multilayer ceramic capacitor 106 according to a modification of the second embodiment. As illustrated in FIG. 14, in the multilayer ceramic capacitor 106 of the modification of the second embodiment, the metal layer 22b is provided so as to cover a part of each of the end portions 40. The other configuration is the same as that of the second embodiment, and the descriptions thereof are omitted. As in the modification of the second embodiment, the metal layer 22b may cover a part of each of the end portion 40. The metal layer 22a is provided so as to cover the tips of the metal layer 22b.

### Third Embodiment

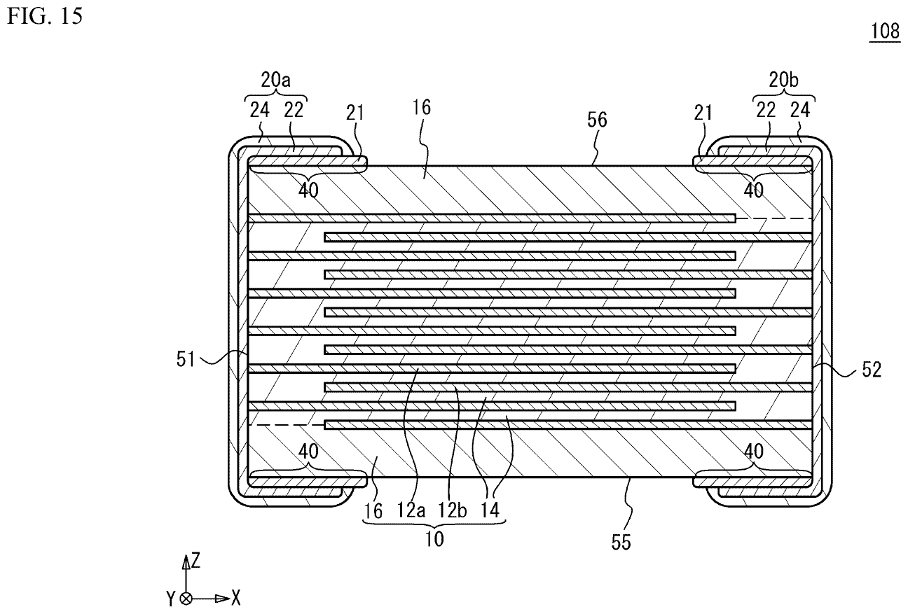

FIG. 15 is a cross-sectional view of a multilayer ceramic capacitor 108 according to the third embodiment. As illustrated in FIG. 15, in the multilayer ceramic capacitor 108 of the third embodiment, each of the base metal layers 22 is a single metal layer. The base metal layers 22 respectively contact the internal electrodes 12a and 12b at the end surfaces 51 and 52, and respectively sandwich the glass layers 21 with the element body 10 at the end portions 40. The plating layers 24 are provided so as to respectively cover the base metal layers 22, and the tip portion of each of the plating layers 24 is in contact with the glass layer 21 and not in contact with the element body 10. The other configuration is the same as that of the first embodiment, and the descriptions thereof are omitted.

### Manufacturing Method of Third Embodiment

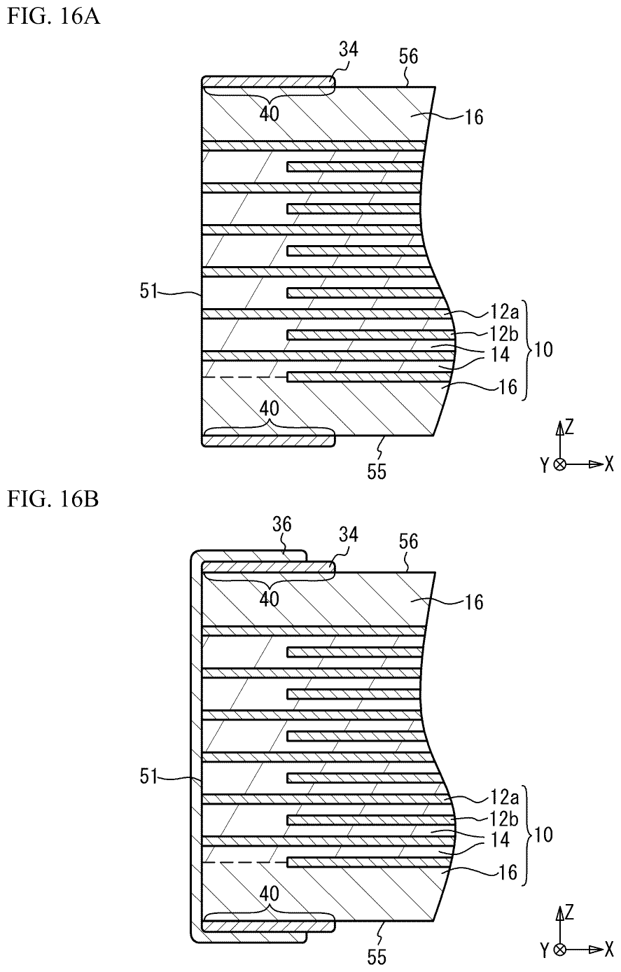

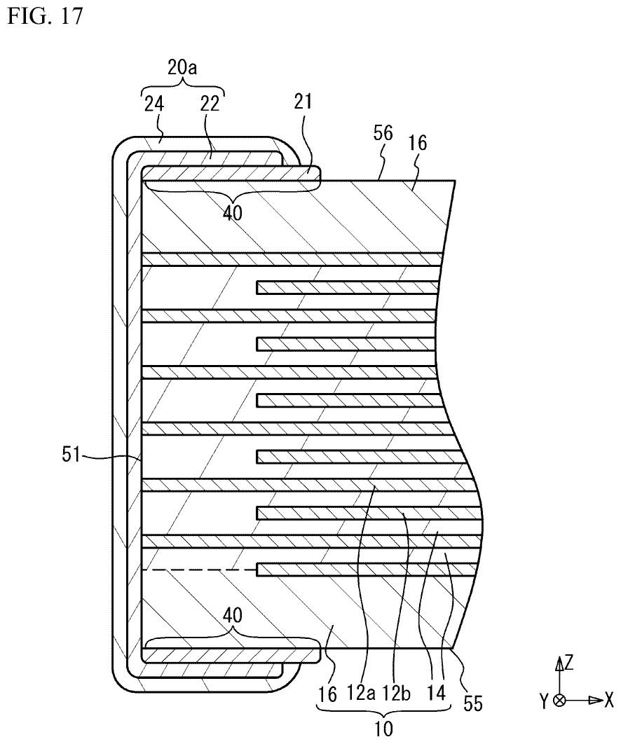

First, the processes up to the firing process S20 in FIG. 4 are performed. FIGS. 16A to 17 are cross-sectional views illustrating the manufacturing method of the multilayer ceramic capacitor 108 according to the third embodiment. In a paste applying process S22 after the firing process S20, paste 34 is applied to the element body 10. As illustrated in FIG. 16A, the paste 34 is applied to the end portions 40 of the element body 10. The paste 34 is applied to the end portions 40 and the end surface 51 by, for example, a dip method as referred to FIGS. 5A and 5B. The end portions 40 and end surface 51 are coated with the paste 34. Thereafter, the paste 34 applied on the end surface 51 is removed. The paste 34 does not contain metal powder, but contains glass powder including silicon oxide, a binder, and an organic solvent. The glass powder may include at least one metal oxide selected from barium oxide, zinc oxide, calcium oxide, aluminum oxide, magnesium oxide, boron oxide, and the like.

As illustrated in FIG. 16B, the end portions 40 and the end surface 51 are coated with paste 36, for example, by a dip method. The tips of the paste 36 are located closer to the end surface 51 than the tips of the paste 34. The tips of the paste 34 are extended from under the paste 36 so as to be exposed to outside. The paste 30 contains metal powder such as copper powder, and contains glass powder, a binder, and an organic solvent. The glass powder contains at least one metal oxide selected from barium oxide, zinc oxide, calcium oxide, aluminum oxide, magnesium oxide, boron oxide and the like. The glass powder may include silicon oxide, but the concentration of silicon oxide in the paste 36 is lower than that in the paste 34.

Subsequently, the baking process S24 is performed. As illustrated in FIG. 17, the glass layers 21 are formed from the paste 34, and the base metal layer 22 are formed from the paste 36. Each of the glass layers 21 is an inorganic insulator containing silicon oxide and metal oxide, and is amorphous. The base metal layer 22 is mainly composed of a metal such as copper, and each of the glass layer 21 is sandwiched between the base metal layer 22 and the element body 10. The tip of each of the glass layers 21 is extended from under the base metal layer 22 to be exposed to outside. Subsequently, in the plating process S26, the plating layer 24 is formed so as to cover the base metal layer 22. The tips of the plating layer 24 contact the glass layers 21 and do not contact the element body 10. The structure of the plating layer 24 is the same as that of the first embodiment. The base metal layer 22 and the plating layer 24 form the external electrode 20a. Additionally, the external electrode 20b is formed in the same manner as described above. The baking process of the paste 36 may be performed after the baking process of the paste 34.

In the second embodiment, as illustrated in FIG. 16A, the paste 34 containing silicon oxide and not containing metal is applied to the end portions 40 of the element body 10 without being applied to the end surface 51 of the element body 10. As illustrated in FIG. 16B, the paste 36 (conductive paste) is applied to the end surface 51 of the element body 10 and the paste 34. As illustrated in FIG. 17, the base metal layer 22 and the glass layer 21 are formed by baking the pastes 34 and 36. Thus, the glass layer 21 mainly composed of silicon oxide can be formed on the end portions 40.

In FIG. 17, the glass layer 21 is formed over a whole area of the end portions 40, but the glass layer 21 may be provided next to the tip of the base metal layer 22 as illustrated in FIG. 9.

In the present embodiment, the concentration of Si is measured by using, for example, a scanning transmission electron microscope (STEM)—energy dispersive X-ray spectroscopy (EDS) method. A glass is irradiated with an electron beam, and the molar ratio of Si to the whole glass is calculated from the peaks of Si and metal elements in the glass to obtain the concentration of Si. The same method as described above is used to measure the concentration of Si in the conductive paste. The concentration of Si may be measured at any portion of the corresponding layer. The expression “a certain material contains an element or a molecule as a main component” means that the material contains an element or a molecule enough to obtain the effect of the embodiment, and the concentration of the element or molecule in the material is, for example, 50 mol % or more, 80 mol % or more, or 90 mol % or more.

The present invention is not limited to the specific embodiment, and various modifications and changes may be made within the scope of the gist of the present invention described in the claims.

What is claimed is:

1. A multilayer ceramic electronic component comprising:
an element body, in which internal electrodes and dielectric layers mainly composed of ceramic are alternately laminated in a first direction, having end surfaces facing each other in a second direction and a neighboring surface connected to the end surfaces, the internal electrodes being alternately drawn to the end surfaces;
an external electrode that includes a base metal layer and a plating layer and is provided on the element body; and
a glass layer provided on an end portion of the neighboring surface at a side of one of the end surfaces, wherein
the base metal layer contacts a part of the internal electrodes drawn to the one of the end surfaces and is provided at the end portion,
the glass layer is provided from under a tip portion of the base metal layer to an opposite side of the end surfaces on the end portion, and
the plating layer is provided so as to sandwich the base metal layer and the glass layer with the element body at the end portion.

2. The multilayer ceramic electronic component according to claim 1, wherein
the glass layer includes silicon oxide.

3. The multilayer ceramic electronic component according to claim 2, wherein
the base metal layer includes a first layer and a second layer,
the first layer and the element body sandwich the glass layer at the end portion,
a concentration of Si of the second layer is lower than that of the first layer, and
the second layer contacts the one of the end surfaces.

4. The multilayer ceramic electronic component according to claim 3, wherein
the first layer and the one of the end surfaces sandwich the second layer.

5. The multilayer ceramic electronic component according to claim 3, wherein
the first layer is not provided on the one of the end surfaces.

6. The multilayer ceramic electronic component according to claim 1, wherein
the plating layer is not in contact with the element body.

7. A manufacturing method of a multilayer ceramic electronic component comprising:
preparing an element body, in which internal electrodes and dielectric layers mainly composed of ceramic are alternately laminated in a first direction, having end surfaces facing each other in a second direction and a neighboring surface connected to the end surfaces, the internal electrodes being alternately drawn to the end surfaces;
applying first conductive paste containing glass powder including silicon oxide so as to contact an end portion of the neighboring surface at a side of one of the end surfaces;
applying second conductive paste having a lower concentration of Si oxide than the first conductive paste so as to contact the one of the end surfaces;
baking the first conductive paste and the second conductive paste to form a base metal layer and a glass layer, the base metal layer being provided at the end portion and contacting a part of the internal electrodes drawn to the one of the end surfaces, the glass layer containing silicon oxide and being provided from under a tip portion of the base metal layer to an opposite side of the end surfaces on the end portion; and
forming a plating layer at the end portion so as to sandwich the base metal layer and the glass layer with the element body, the plating layer and the base metal layer forming an external electrode of the multilayer ceramic electronic component.

8. The manufacturing method according to claim 7, wherein
the applying of the first conductive paste is performed so as to form the first conductive paste on the end portion without providing the first conductive paste on the one of the end surfaces, and
the applying of the second conductive paste is performed after the applying of the first conductive paste.

9. The manufacturing method according to claim 7, wherein
the applying of the first conductor paste applies the first conductor paste so as to cover the second conductor paste after the applying of the second conductor paste.

10. A manufacturing method of a multilayer ceramic electronic component comprising:
preparing an element body, in which internal electrodes and dielectric layers mainly composed of ceramic are alternately laminated in a first direction, having end surfaces facing each other in a second direction and a neighboring surface connected to the end surfaces, the internal electrodes being alternately drawn to the end surfaces;
applying paste containing silicon oxide on an end portion of the neighboring surface at a side of one of the end surfaces without applying the paste on the one of the end surfaces;
applying conductive paste on the one of the end surfaces of the element body and the paste;
baking the paste and the conductive paste to form a base metal layer and a glass layer, the base metal layer being provided at the end portion and contacting a part of the internal electrodes drawn to the one of the end surfaces, the glass layer containing silicon oxide and being provided from under a tip portion of the base metal layer to an opposite side of the end surfaces on the end portion; and
forming a plating layer at the end portion so as to sandwich the base metal layer and the glass layer with the element body, the plating layer and the base metal layer forming an external electrode of the multilayer ceramic electronic component.
